(19) United States
(12) Patent Application Publication
(10) Pub. No.: US 2025/0371565 A1
(43) Pub. Date: Dec. 4, 2025

(54) REACH AND FREQUENCY FORECAST MODELS

(71) Applicant: Disney Enterprises, Inc., Burbank, CA (US)

(72) Inventors: Tara L. STEUBER, Orlando, FL (US); AjayDas KAKI, Windermere, FL (US); Nicholas A. CAMBRIA, Windermere, FL (US); Allyson E. LARSEN, Orlando, FL (US)

(21) Appl. No.: 19/179,832

(22) Filed: Apr. 15, 2025

Related U.S. Application Data
(60) Provisional application No. 63/655,259, filed on Jun. 3, 2024.

(51) Int. Cl. G06Q 30/0202; G06Q 30/0204

(52) U.S. Cl. CPC G06Q 30/0202; G06Q 30/0204

(57) ABSTRACT

Embodiments provide for improved machine learning. A first distribution plan for content is accessed, where the first distribution plan comprises a first target segment and identifies a first set of distribution outlets. A base segment corresponding to the target segment is determined, where the target segment is defined based on a plurality of member attributes and the base segment is defined based on a subset of the plurality of member attributes. A set of forecasts is generated using, for each respective distribution outlet of the first set of distribution outlets, a respective machine learning model trained based on the base segment. A forecasted reach metric for the first distribution is generated plan based on the set of forecasts.

### CROSS-REFERENCE TO RELATED APPLICATION(S)

The present application for patent claims the benefit of priority to U.S. Provisional Appl. No. 63/655,259, filed Jun. 3, 2024, which is hereby incorporated by reference herein in its entirety.

### BACKGROUND

Reach and frequency are important metrics for a variety of distribution plans, including a wide variety of marketing campaigns. Typically, reach and frequency are calculated post-campaign based on viewers of content compared to the overall potential viewing universe. Forecasting reach and frequency, prior to a campaign, is a challenging problem.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 illustrates an example environment for evaluating and implementing distribution plans, according to some embodiments of the present disclosure.

FIG. 2 illustrates a computing environment for forecasting reach and frequency using models, according to some embodiments of the present disclosure.

FIG. 3 is a block diagram illustrating a controller for forecasting reach and frequency using models, according to some embodiments of the present disclosure.

FIG. 4 is a flowchart depicting a method for forecasting reach and frequency using models, according to some embodiments of the present disclosure.

FIG. 5 is a flowchart depicting a method for generating cross-outlet forecasts using outlet-specific models, according to some embodiments of the present disclosure.

FIG. 6 is a flowchart depicting a method for generating target forecasts using generalized models, according to some embodiments of the present disclosure.

FIGS. 7A-C illustrate cross-outlet reach for forecasting reach and frequency using models, according to some embodiments of the present disclosure.

FIG. 8 is a flowchart depicting a method for generating forecasts using machine learning models, according to some embodiments of the present disclosure.

### DETAILED DESCRIPTION

Increasingly, a large variety of entities engage in distribution of a vast assortment of items, including physical items (e.g., goods), virtual items (e.g., media content), and the like. Often, an important goal of such distribution is to ensure that the items are distributed to a large number of individuals while incurring a minimum cost or expense. To that end, effective distribution planning is increasingly important today. However, effective planning often relies on predicting how effective a given plan will be. Current techniques to predict such efficacy prior to implementing the plan are insufficiently accurate.

For example, purveyors of a campaign (e.g., an advertising campaign or any other suitable campaign) may work with a planning team to purchase or schedule certain types of programming or distribution options (e.g., times, places, and/or modalities to distribute materials), during which to air or otherwise output for display supporting materials for the campaign (e.g., supplemental content or any other suitable supporting materials). Generally, a variety of information is relevant to assembling a full distribution plan for the content, including the target audience for the content (referred to in some aspects as the target segment). In some embodiments, the target segment can be defined based on general demographics, one common of which is age-sex (e.g., all people between the ages of 18 and 49, males 50 and over, or any other suitable demographic). In many cases, the target segment is substantially more specific, such as by including a general demographic component as well as any number of other more specific attributes (e.g., captured or determined using survey questions).

For example, these additional attributes may identify a person's interest in various aspects of the content (e.g., interest in buying or current ownership of a given product), may indicate other characteristics of the target individuals (e.g., dog owners, people who live in a given region, and the like). In some embodiments, planners can identify requirements or preferences that should be satisfied by the distribution plan, such as optional advertiser requirements relating to the total cost (budget), the mix of programming on which their content will be distributed, the mix of time of day when the content will be distributed, and the like.

In many cases, content providers have a variety of metrics that is desired to be optimized or increased by the distribution plan. These metrics can include a wide variety of attributes to measure the effectiveness of a distribution plan, including the total number of views or listens (e.g., impressions), the number of unique individuals that consumed the content (e.g., reach), the number of times an individual saw the ad (e.g., frequency), or any other suitable metric(s).

In some embodiments of the present disclosure, a variety of models (e.g., machine learning models) are used to forecast metrics of interest (e.g., reach) for distribution plans prior to implementation of the plans. In some embodiments, the reach of a given plan is defined based on the target segment (e.g., the set of individuals being targeted by the plan). That is, the reach may correspond to the percentage of the target population that actually consumes, receives, or views the content. For example, suppose the target segment of a given distribution plan is women under forty who own at least two dogs and are interested in driving a truck. Suppose further that the target population has a size of T (e.g., there are T women under forty who own two or more dogs and are interested in driving trucks). In some aspects, the target population corresponds to the number of individuals that meet the target segment criteria and that are “reachable” (e.g., that can be reached via at least one distribution outlet). For example, if one potential distribution outlet is a specific channel of television, the target population may be women under forty who own at least two dogs, are interested in driving trucks, and are subscribed to or otherwise consume the specific channel.

In some aspects, therefore, the “reach” of a distribution plan for this target segment may be defined as the percentage of the total (reachable) target population T that actually receive or consume the content distributed by the plan. However, given that there are a virtually infinite number and variety of attributes that can be used to define a given target segment, there is a similarly infinite set of target segments. That is, the number of variables to be considered in common implementations renders direct computation or evaluation of the various combinations effectively impossible. Accordingly, it is simply impossible to generate or train computational or mathematical models (e.g., machine learning models) for each possible target segment. Further, it is not practical to train a target-specific model in real-time (e.g., once a proposed distribution plan is received), as the training data for the given segment generally does not exist. That is, because there are an infinite number of possible target segments, it is not possible to have training data for all such segments. Further, even if data exists for a given segment, the computational expense and latency of the training process may be prohibitive, preventing real-time analysis of a given plan.

Further, use of more generalized predictive models (e.g., that do not take into account the target segment) is generally insufficient, as these general models are inherently limited in their ability to grasp the specifics of a given segment. For example, predicting the number of individuals who will consume a given piece of media content has little (if any) value in predicting the number of women over forty who own at least two dogs and are interested in driving trucks and will also consume the content.

Therefore, in some embodiments of the present disclosure, techniques are provided to generate highly specified predictions (e.g., accurate forecasts for specific target segments) by combining pre-trained generic (e.g., not segment-specific) models and data that can be obtained in real-time for such specific segments. In these ways, embodiments of the present disclosure can substantially reduce computational expense of the predictive systems (e.g., because there is no need to store the vast amounts of training data for each target segment, as well as because there is no need to train a vast assortment of target-specific models for vast number of possible target segments (which can easily number in the trillions or quadrillions)). That is, by refraining from training or using models for every target segment (resulting in effectively infinite permutations) and instead using a more targeted approach (e.g., using more general models and then refining the predictions), embodiments of the present disclosure can enable highly accurate predictions (e.g., for such specific segments) without incurring the expense of training or maintaining such specific models.

In some embodiments, techniques are provided to use machine learning models trained for base segments (e.g., more generalized segments) to generate initial forecasts, and these initial forecasts can be modified or revised to reflect a specific target segment specified in a distribution plan, as discussed in more detail below. This allows for highly specific predictions (e.g., predicted reach for a specific target segment) using generalized models and reduced computational expense.

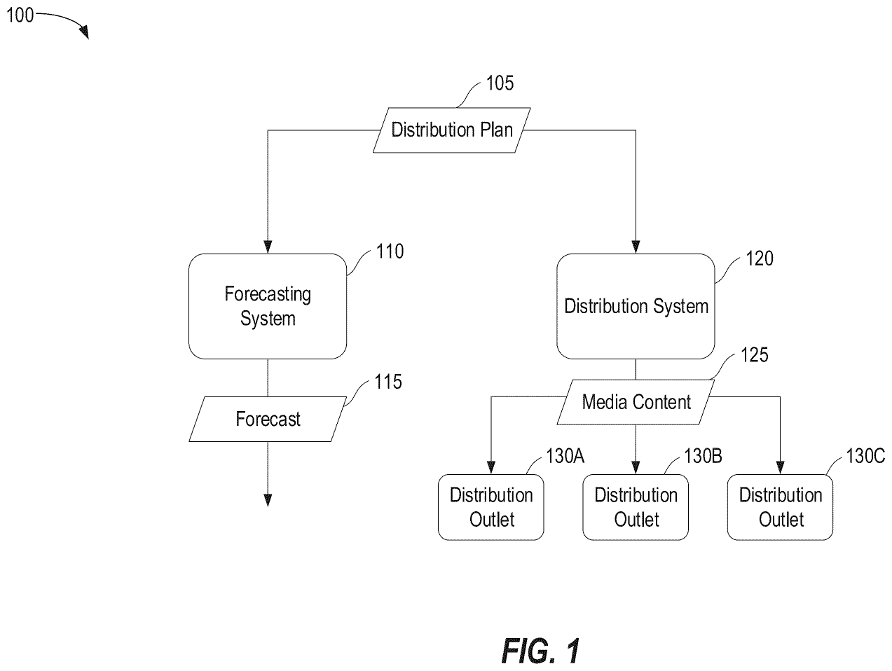

FIG. 1 illustrates an example environment 100 for evaluating and implementing distribution plans, according to some embodiments of the present disclosure.

In the illustrated example, a distribution plan 105 can be accessed and evaluated by a forecasting system 110 to generate one or more forecasts 115 relating to the predicted effects of the distribution plan 105 if it is implemented. As discussed above, a distribution plan may generally correspond to a strategy to distribute media content (e.g., advertisements) and may specify aspects such as one or more target audiences for the distribution plan (referred to as target segments in some aspects, as discussed above). In some aspects the distribution plan 105 specifies or identifies a set of distribution outlets that are proposed to be used to distribute the content, such as specifying particular channels or networks of television, particular websites, and the like. Generally, a distribution outlet may represent any medium or avenue by which users can consume data (e.g., media, figures, facts, or any other information). In some embodiments, the distribution plan 105 may include other characteristics or information, such as a target or maximum cost, a duration, and the like. In some embodiments, the distribution plan 105 may be manually created, or may be automatically created, as discussed in more detail below. Although the illustrated example depicts a single distribution plan 105 for conceptual clarity, in some embodiments, multiple distribution plans can be effectively evaluated in sequence or in parallel.

In the illustrated example, the forecasting system 110 is generally representative of any computing system capable of performing various embodiments of the present disclosure. Although pictured as a discrete system for conceptual clarity, in some embodiments, the operations of the forecasting system 110 may be performed by any number and variety of components across any number of systems, and each may generally be implemented using hardware, software, or a combination of hardware and software. In some embodiments, as discussed above and in more detail below, the forecasting system 110 can generally use one or more machine learning models to generate the forecast 115 based on input distribution plans 105.

For example, in some embodiments, the forecasting system 110 may use a variety of outlet-specific models, each trained to generate outlet-specific forecasts for a corresponding outlet. In some embodiments, these outlet-specific forecasts may correspond to base or broad segments. For example, if a target segment is men under fifty who own a cat and drive a particular type of vehicle, the forecasting system 110 may identify the corresponding base segment as men under fifty. As discussed above, in some embodiments, the base segment for a given target segment may correspond to the age-sex demographics of the target segment. In some embodiments, to identify the appropriate base segment, the forecasting system 110 may identify the segment that includes the target segment and most closely matches the target segment, and has a machine learning model trained for the segment. For example, if the target segment is men under fifty and the forecasting system 110 determines that one model was trained for men between 40 and 50 and another was trained for men between 30 and 50, the forecasting system 110 may determine that the latter model (trained for men between 30 and 50) as the appropriate base segment because this segment is closer to the specified target segment (e.g., including men 30-40, which are included in the target segment but are excluded by the first model).

In some embodiments, after generating an outlet-specific forecast for the identified base segment, the forecasting system 110 may modify or refine this forecast based on the target segment (e.g., to more closely indicate the predicted reach with respect to the specific target), as discussed above and in more detail below. In some embodiments, the forecasting system 110 may perform such analysis to generate a set of targeted outlet-specific forecasts (e.g., for each outlet specified in the distribution plan 105 and based on the indicated target segment(s)). In some embodiments, the forecasting system 110 may then aggregate these outlet specific forecasts to generate the overall forecast(s) 115 of the distribution plan 105. In some embodiments, as discussed above and in more detail below, the forecasting system 110 may use a variety of techniques to aggregate the outlet-specific forecasts while accounting for potential overlap in the users who consume media via each outlet, in order to generate a more accurate prediction.

Generally, the forecast 115 may correspond to or include a wide variety of predictions, depending on the particular implementation. For example, in some embodiments, the forecast 115 may indicate the predicted or forecasted reach of the distribution plan 105 (referred to as a “forecasted reach metric” in some embodiments), where the “reach” of the plan corresponds to the number of unique individuals who will see or consume at least one piece of content being distributed under the distribution plan 105 (e.g., the number of unique individuals who will see at least one advertisement included in the distribution plan 105). As another example, in some embodiments, the forecast 115 may include the predicted frequency (referred to in some aspects as a “forecasted frequency metric”), which indicates the average number of times a given individual is expected to see or consume content under the distribution plan, given that they view at least one such piece of content (e.g., the average number of advertisements seen by individuals who receive at least one advertisement under the distribution plan 105). As yet another example, in some embodiments, the forecast 115 may include the predicted impressions (referred to in some aspects as a “forecasted impression metric”), which indicates the total number of times that content included in the distribution plan 105 will be seen during the course of the campaign.

In some embodiments, the forecasting system 110 may evaluate multiple distribution plans 105 in order to generate corresponding forecasts 115, allowing users to select from among the distribution plans 105 for implementation. That is, the forecasting system 110 may facilitate implementation of a distribution plan 105 based on the forecasts 115. In the illustrated example, once a distribution plan 105 is selected, it can be implemented by a distribution system 120.

In the illustrated example, the distribution system 120 is generally representative of any computing system capable of performing various embodiments of the present disclosure. Although pictured as a discrete system for conceptual clarity, in some embodiments, the operations of the distribution system 120 may be performed by any number and variety of components across any number of systems, and each may generally be implemented using hardware, software, or a combination of hardware and software. In some embodiments, the distribution system 120 may generally control distribution of media content 125 via a variety of distribution outlets 130A-C according to input distribution plans 105. Further, although distributing digital media is used in some examples described herein, embodiments of the present disclosure are similarly applicable to controlling the distribution or display of other content (e.g., printed information) via digital and/or non-digital distribution outlets (e.g., modalities such as billboards, pamphlets that can be handed to users, and the like).

For example, as discussed above, the distribution plan 105 may indicate a mix of distribution outlets 130A-C (collectively, distribution outlets 130) that should be used to distribute the media content 125 (e.g., a set of one or more advertisements), as well as a target segment for the content. As discussed above, each distribution outlet 130 may generally correspond to any medium via which media content 125 can be delivered. For example, one distribution outlet 130 may correspond to a particular channel (e.g., on cable television), one distribution outlet 130 may correspond to a particular streaming service or website (or subset thereof, such as a particular show or influencer on such a service), a particular magazine brand, and the like. The media content 125 is generally representative of any content that is being distributed, such as advertisements.

As discussed above, the distribution system 120 may generally distribute the media content 125 to individual users via the various distribution outlets 130 in accordance with the distribution plan 105. Although three distribution outlets 130A-C are depicted for conceptual clarity, in embodiments, there may be any number and variety of distribution outlets 130 accessible via the distribution system 120.

Although not depicted in the illustrated example, in some embodiments, the distribution system 120 (or another system) may monitor the distribution of the media content 125 in order to determine the real-world statistics for the distribution plan 105. For example, the distribution system 120 may determine the actual reach of the plan, the actual frequency, the actual number of impressions, and the like. In some embodiments, this updated information may be used to further refine the reach model(s). For example, by comparing the actual reach (with respect to the target segment and/or the base segment) with the forecasted reach, the distribution system 120 may refine one or more of the reach prediction machine learning models. As another example, in some embodiments, when sufficient real-world data is generated for a given target segment (e.g., more specific than the base segment), the distribution system 120 may optionally train a new model for this new segment. If the segment is one that is re-used frequently, this may substantially improve future forecasts.

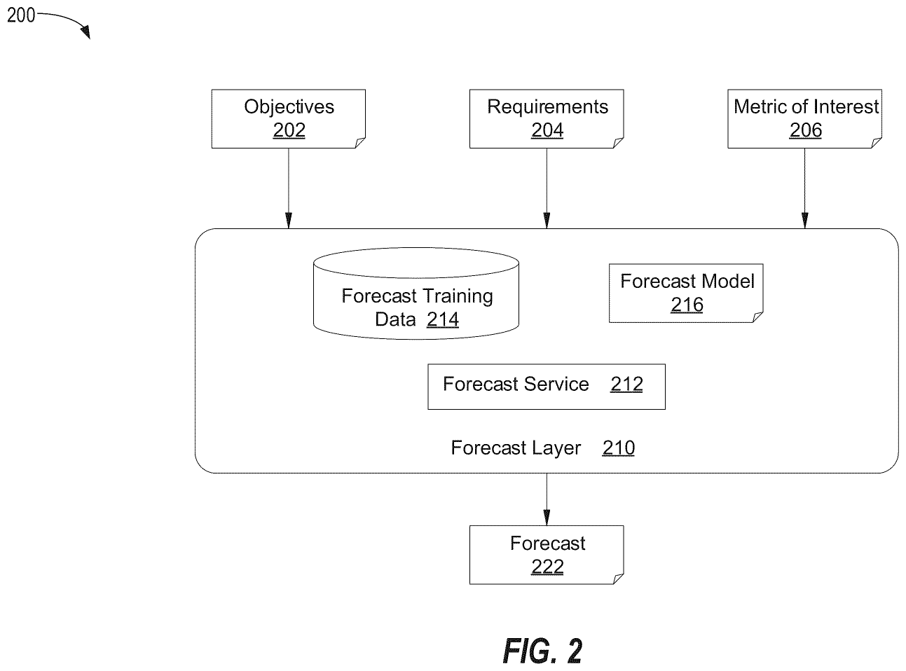

FIG. 2 illustrates a computing environment 200 for forecasting reach and frequency using models, according to one embodiment. A forecast layer 210 receives a variety of data, and uses the data to generate a forecast 222 (which may correspond to the forecast 115 of FIG. 1). For example, the forecast layer 210 can receive objectives 202, requirements 204, and one or more metrics of interest 206.

The objectives 202 can include a target audience or segment for the content. This can include an age-sex demographic, attributes (e.g., from a suitable survey), or any other suitable objectives. The requirements 204 can include advertiser requirements that need to be satisfied (e.g., the mix of programming on which ads will air, mix of time of day when the ads will air, budget, average cost per mile (CPM)), content provider requirements, or any other suitable requirements. The metric of interest 206 can include one or more metrics that an advertiser wants to optimize or increase. (e.g., impressions, reach, frequency, or any other suitable metric(s)).

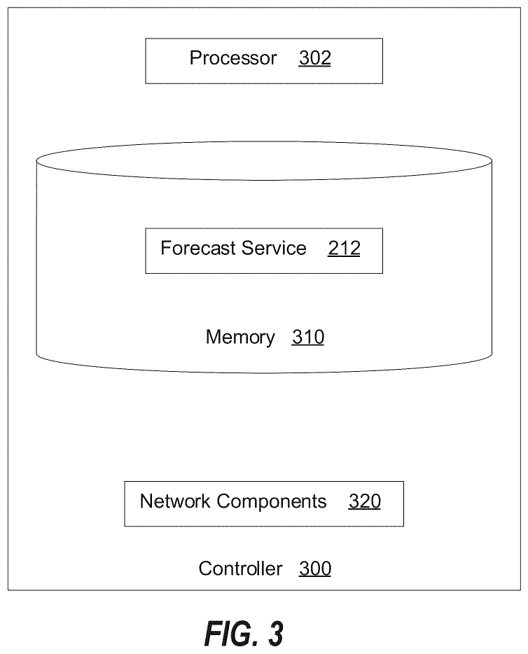

In an embodiment, the forecast layer 210 includes a forecast service 212. In some embodiments, the forecast layer 210 and/or the forecast service 212 may correspond to the forecast system 110 of FIG. 1. For example the forecast service 212 can be a suitable software service to facilitate forecasting reach and frequency using models. As discussed further, below, with regard to FIG. 3, the forecast service 212 can use a variety of input features, such as the objectives 202, requirements, 204, metric of interest 206, or any combination thereof, to generate forecast training data 214 and/or to train one or more forecast models 216 (e.g., a machine learning (ML) model or any other suitable scientific model) using the forecast training data 214. The forecast model can be any suitable ML model, including a supervised ML model (e.g., a neural network, including a deep learning neural network, or any other suitable supervised ML model) or an unsupervised ML model. Further, the forecast model 216 can be a rules-based model (e.g., instead of, or in addition to, an ML model), or any other suitable type of model. In an embodiment, the forecast service 212 uses the one or more forecast models 216 (e.g., a trained forecast model 216) to generate forecasts 222.

In an embodiment, the various components of the computing environment 200 communicate using one or more suitable communication networks, including the Internet, a wide area network, a local area network, or a cellular network, and uses any suitable wired or wireless communication technique (e.g., WiFi or cellular communication). Further, in an embodiment, the forecast layer 210 can be implemented using any suitable combination of physical computing systems, including cloud compute nodes and storage locations or any other suitable implementation.

For example, the forecast layer 210, including the forecast service 212, forecast training data 214, and forecast model 216, can be implemented using a respective server or cluster of servers. As another example, the forecast layer 210, including the forecast service 212, forecast training data 214, and forecast model 216 can be implemented using a combination of compute nodes and storage locations in a suitable cloud environment. For example, one or more of the components of the forecast layer 210, including the forecast service 212, forecast training data 214, and forecast model 216 can be implemented using a public cloud, a private cloud, a hybrid cloud, or any other suitable implementation.

FIG. 3 is a block diagram illustrating a controller 300 for forecasting reach and frequency using models, according to one embodiment. In an embodiment, the controller 300 corresponds with one aspect of the forecast layer 210 illustrated in FIG. 2. That is, the controller 300 may correspond to or implement some or all of the forecast system 110 of FIG. 1. The controller 300 includes a processor 302, a memory 310, and network components 320. The processor 302 generally retrieves and executes programming instructions stored in the memory 310. The processor 302 is included to be representative of a single central processing unit (CPU), multiple CPUs, a single CPU having multiple processing cores, graphics processing units (GPUs) having multiple execution paths, and the like.

The network components 320 include the components necessary for the controller 300 to interface with components over a network (e.g., as illustrated in FIG. 2). For example, the controller 300 can be a part of the forecast layer 210, and the controller 300 can use the network components 320 to interface with remote storage and compute nodes using the network components. Alternatively, or in addition, the controller 300 can correspond with a different part of the computing environment 200.

The controller 300 can interface with other elements in the system over a local area network (LAN), for example an enterprise network, a wide area network (WAN), the Internet, or any other suitable network. The network components 320 can include wired, WiFi or cellular network interface components and associated software to facilitate communication between the controller 300 and a communication network.

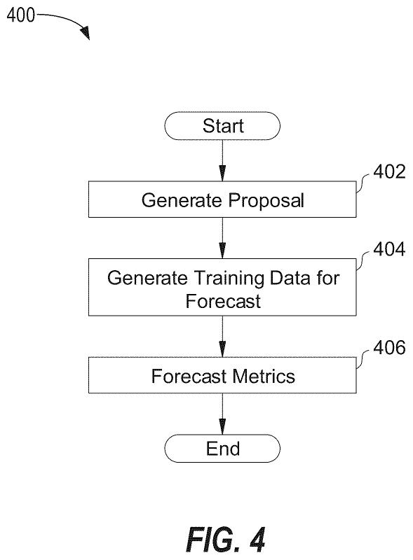

Although the memory 310 is shown as a single entity, the memory 310 may include one or more memory devices having blocks of memory associated with physical addresses, such as random access memory (RAM), read only memory (ROM), flash memory, or other types of volatile and/or non-volatile memory. The memory 310 generally includes program code for performing various functions related to use of the controller 300. The program code is generally described as various functional “applications” or “services” within the memory 310, although alternate implementations may have different functions and/or combinations of functions. Within the memory 310, a forecast service 212 facilitates forecasting reach and frequency using models. This is discussed further below with regard to FIGS. 4-6.

Although FIG. 3 depicts the forecast service 212 as located in the memory 310, the illustrated representation is merely provided as an illustration for clarity. More generally, the controller 300 may include one or more computing platforms, such as computer servers for example, which may be co-located, or may form an interactively linked but distributed system, such as a cloud-based system (e.g., a public cloud, a private cloud, a hybrid cloud, or any other suitable cloud-based system). As a result, the processor 302 and memory 310 may correspond to distributed processor and memory resources within a computing environment.

FIG. 4 is a flowchart depicting a method 400 for forecasting reach and frequency using models, according to some embodiments of the present disclosure. In some embodiments, the method 400 is performed by a forecasting system or service, such as the forecasting system 110 of FIG. 1, the forecasting layer 210 of FIG. 2, and/or the forecasting service 212 of FIGS. 2-3.

At block 402, a forecast system (e.g., the forecast system of FIG. 1 and/or the forecast service 212 illustrated in FIGS. 2-3) generates proposals (e.g., distribution plans such as the distribution plan 120 of FIG. 1). In an embodiment, the forecast system uses a hierarchical optimization approach to generate the proposals. In some aspects, in addition to or instead of generating the proposals, the forecast system may receive one or more proposed distribution plans 105 (e.g., from a user).

For example, rather than simultaneously trying to forecast a metric of interest in an objective function, and solve an optimization problem, the forecast system can split the problem into steps. The forecast system can solve the primary objective that satisfies all the requirements from the advertisers and the content provider's inventory strategy. In an embodiment, the forecast system generates a solution pool of multiple proposals that satisfy the criteria as closely as possible, which can be termed an offer family. The forecast system scores each offer in the offer family. For example, the forecast system can forecast a metric of interest, and pick the best one. This is merely one example, and any suitable technique can be used. A solution pool saves run time by producing suitable solutions simultaneously instead of solving similar problems sequentially.

At block 404, the forecast system generates or accesses training data for forecasts (e.g., forecast training data 214 illustrated in FIG. 2). In an embodiment, for each proposal (e.g., generated at block 402) a reach metric is forecast for a variety of contexts (e.g., a broadcast quarter, cross-outlet, and target segment chosen by the advertiser). For example, cross-outlet reach means that reach is calculated across all the outlets present on the proposal, as opposed to individual reach which would calculate reach for each outlet independently.

In an embodiment, the outlets present can be any combination of outlets relating to the content provider. For example, a given content provider may operate a number of television or radio platforms, video or audio streaming services, video game services, or any other suitable outlets. The outlets desired by a given content provider can be any combination of these outlets, but because of the very large number of possible combinations, many combinations will be sparse in the historical data, especially when the outlets have not frequently been used together in a single distribution plan.

In one embodiment, the forecast system could produce training data for all combinations. But this is wasteful and inefficient (e.g., in terms of computational resources, memory usage, and other resources), because many possible combinations will not be observed and aren't worth the computational effort or data storage. Further, since a content provider can select any number attributes (e.g., any combination of 50,000 available attributes) to define a target segment, the number of potential segments is nearly limitless. This means segments cannot, effectively, be pre-computed because they are generated on the fly by the users. Further, such an approach would introduce intolerable latency (e.g., requiring many hours of computations). This presents an issue since proposals need to be returned or evaluated in a reasonable amount of time to the planners for review, as discussed above.

To deal with these issues, in an embodiment the forecast system breaks up the problem into components that are easier to forecast in a batch and compute metrics in real time to translate the results to the exact target segment and cross-outlet combination. For the target segment issue, the forecast system may first recognize that each target segment has a general or base component, such as age-sex. There are a relatively small number of age-sex combinations that content providers frequently care about, and the forecast system can identify those frequently used combinations (e.g., people age 18-49, males 50+, females 50+, or any other suitable combination).

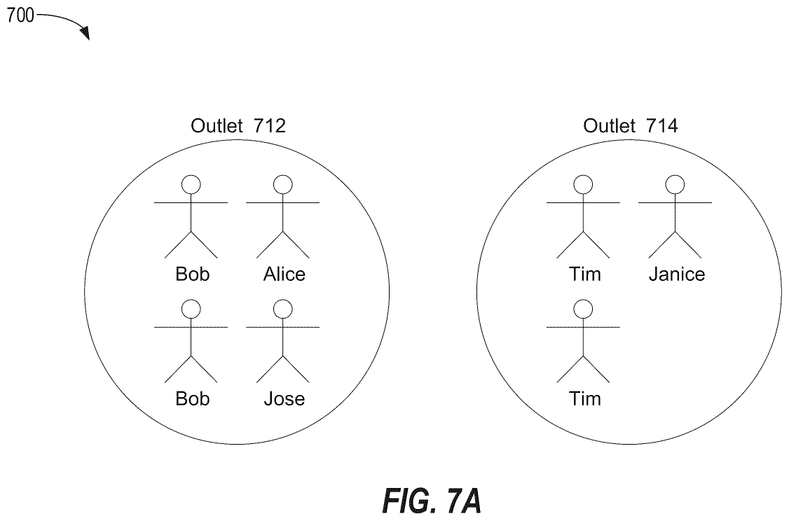

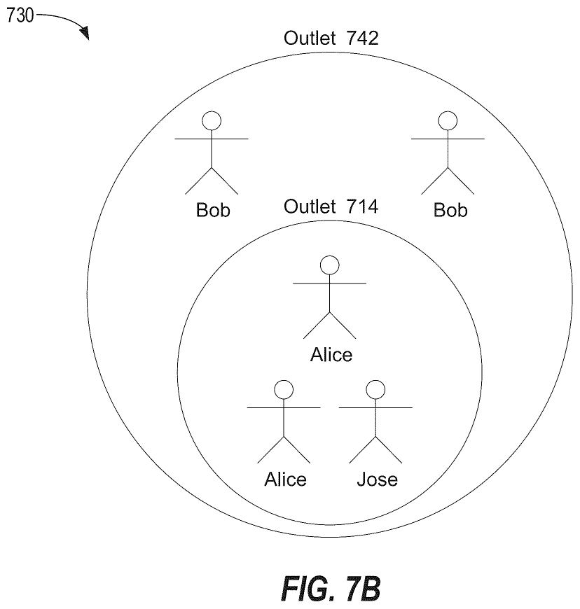

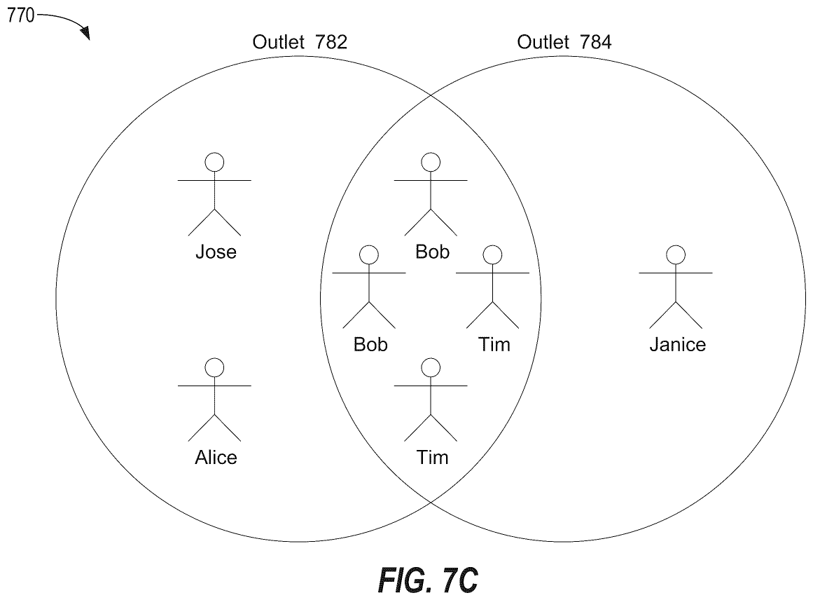

For cross-outlet reach, in some embodiments, the forecast system may exploit the natural lower and upper bounds of the outlet-specific forecasts. That is, because reach is defined as the unique number of individuals that consume the content, cross-outlet reach is bounded below by the maximum value of reach on any single outlet (e.g., the minimum reach will be the largest single-outlet forecast), referred to in some embodiments as the “lower bound.” Further, the cross-outlet reach is bounded above by the sum of the reach values of each outlet (e.g., the maximum reach is the sum of all individual outlets), referred to in some embodiments as the “upper bound.” This is discussed further, below, with regard to FIGS. 7A-C.

At block 406, the forecast service forecasts metrics (e.g., using the forecast model 216 illustrated in FIG. 2). In an embodiment, the forecast service combines the components described above (e.g., in relation to blocks 402 and 404) to generate a forecast for cross-outlet reach for a target segment. For example, first the forecast service forecasts reach by the general component of the target segment for each individual outlet and broadcast quarter. One or more models (e.g., ML models or other scientific models) can be trained in a batch process and scored in real time for the given distribution proposal. That is, the models may be used to predict the target metric (e.g., reach) for the base segment with respect to each outlet.

Next, in an embodiment, in real time (or near real time) the forecast system can compute the ratio between the base segment and the target segment population. For example, the forecast system may multiply the base segment forecast with the base-to-target ratio to generate a forecast for reach on the given outlet with respect to the specific target segment (e.g., including a suitable time period, like a broadcast quarter, a target segment, and any other suitable attributes).

In some embodiments, cross-outlet reach can be defined as a convex combination of the max individual (outlet-specific) reach estimates and the sum of individual (outlet-specific) reach estimates with respect to the target segment. That is, in some embodiments, the forecast system can forecast cross-outlet reach by forecasting or selecting the best value of alpha in the convex combination below. The convex combination produces a value that is in between the two values as long as alpha is between 0 and 1. In some aspects, the cross-outlet reach (e.g., the forecasted reach metric) can be defined as reach=α*Upper_Bound+(1-α)*Lower_Bound, where reach is the forecasted reach metric for the distribution plan, α is a hyperparameter (referred to in some aspects as a cross-outlet weight), and Upper_Bound and Lower_Bound are the largest and smallest possible aggregate reach metrics, respectively, as discussed above.

In some embodiments, the forecasting service may determine a value for the cross-outlet weight α based on historical information related to the current distribution plan in a hierarchical fashion. That is, the forecasting service may evaluate the actual reach of previous distribution plans to estimate the cross-outlet weight for the current plan. For example, in some embodiments, the forecasting service may determine the average historical cross-outlet weight for prior plans having the same combination of outlets and the same base segment (e.g., for historical plans using the same set of distribution outlets and with the same base segment, even if the target segments differ).

In some embodiments, if this historical average is not available (e.g., there are an insufficient number of prior examples having the same outlet combination and base segment), the forecasting service may find, in the historical data, the smallest outlet combination that includes the target outlet combination of the current plan (e.g., historical plans that include each of the outlets in the current plan, as well as one or more additional outlets). The forecasting service may then compute the average historical cross-outlet weight with respect to this matched or similar outlet combination and base segment.

In some embodiments, if insufficient data exists for this similar outlet combination, the forecasting service may determine the average cross-outlet weight for a combination of parent outlets including the target outlet combination and with respect to the base segment. For example, if one or more of the distribution outlets are hierarchical (e.g., one or more outlets are included under a broader parent outlet), the forecasting service may determine the set of parent outlet(s) that includes the specific target outlets, and may compute the average cross-outlet reach for plans covering these parent outlets (and the same base segment).

In some embodiments, if insufficient data exists for a parent outlet evaluation, the forecasting service may determine the average cross-outlet weight for the base segment across any (or all) outlets. Finally, in some embodiments, if there is insufficient historical data to determine the average cross-outlet weight for the base segment in general, the forecasting service may use a fixed or predefined value such as 0.5 as the cross-outlet weight.

In some embodiments, as additional data is collected (e.g., as additional distribution plans are implemented), the forecasting service can continue to monitor and collect information relating to the cross-outlet weights to enable improved forecasts for subsequent plans.

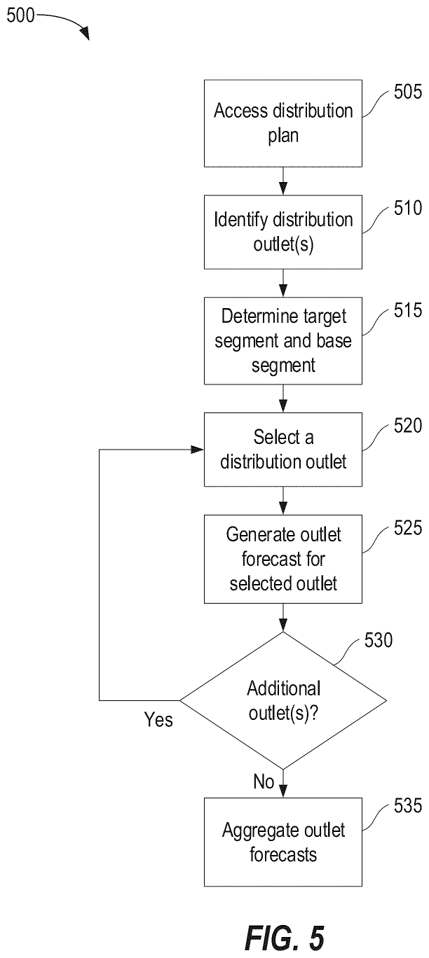

FIG. 5 is a flowchart depicting a method 500 for generating cross-outlet forecasts using outlet-specific models, according to some embodiments of the present disclosure. In some embodiments, the method 500 is performed by a forecasting system or service, such as the forecasting system 110 of FIG. 1, the forecasting layer 210 of FIG. 2, the forecasting service 212 of FIGS. 2-3, and/or the forecasting system discussed above with reference to FIG. 4. In some embodiments, the method 500 provides additional detail for block 406 of FIG. 4.

At block 505, the forecasting system accesses a distribution plan (e.g., the distribution plan 105 of FIG. 1). Generally, as used herein, “accessing” data (such as a distribution plan) may include receiving, requesting, retrieving, generating, collecting, obtaining, or otherwise gaining access to the data. For example, the forecasting system may receive the distribution plan from a user or from another system that generated the plan, or the forecasting system may itself generate the distribution plan, as discussed above.

At block 510, the forecasting system identifies the set of distribution outlets (e.g., the distribution outlets 130 of FIG. 1) that are indicated in the distribution plan. That is, the forecasting system identifies the outlet(s) that are proposed to be used to distribute the content (e.g., the media content 125 of FIG. 1) associated with the distribution plan. As discussed above, the forecasting system may generally specify any number and variety of proposed distribution outlets.

At block 515, the forecasting system determines the target segment(s) of the distribution plan, as well as the corresponding base segment(s) for the plan. For example, as discussed above, the target segment may generally specify the desired audience to any level of granularity and using any number of characteristics or attributes, such as based on the user's demographics information, locales, preferences, hobbies, items owned by the user, styles, and the like. In some embodiments, as discussed above, the base segment may be a broader segment (e.g., a segment that includes all people in the target segment, and may include additional people). In some embodiments, the base segment may be defined by a subset of the criteria used to define the target segment. For example, suppose the target segment is women between the ages of 20 and 30 that live in Europe, speak English as a primary or secondary language, live in an attached dwelling, and ride a bicycle at least once a week. In some embodiments, the base segment may correspond to women between the ages of 20 and 30, or to some other combination such as all women who live in Europe, people between the ages of 20 and 30 who live in Europe, and the like.

In some embodiments, the forecasting system identifies the base segment as the age-sex segment that corresponds to the target. That is, the base segment may be the segment defined by the same age range and sex as the target segment, without regard to any other specific characteristics. In some embodiments, the base segment may generally utilize any desired criteria, such as using age and location, using marital status and hobbies, and the like. In some embodiments, the forecasting system may identify the base segment based on evaluating the model(s) that have been trained for the indicated distribution outlet(s). For example, as discussed above, the forecasting system may find the most specific segment that includes all individuals in the target segment and that has been used to train a machine learning model to forecast various metrics.

At block 520, the forecasting system selects one of the distribution outlets (e.g., a particular television channel, streaming service, website, and the like) specified for the distribution plan. Generally, the forecasting system may use a variety of techniques to select the distribution outlet (including randomly or pseudo-randomly), as each outlet in the indicated combination will be evaluated during the method 500.

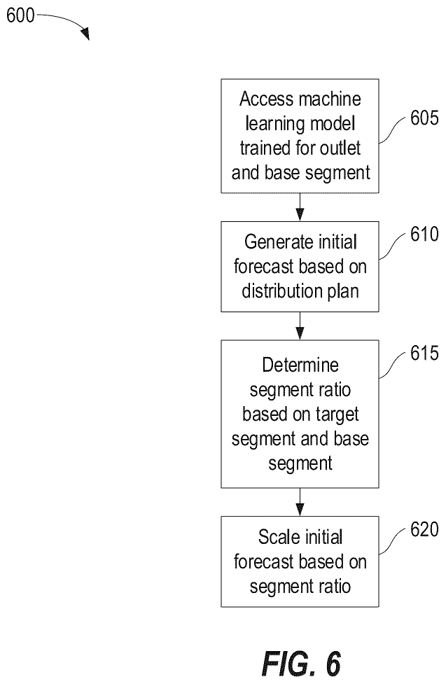

At block 525, the forecasting system generates an outlet-specific forecasted metric (e.g., forecasted reach of the plan with respect to the selected outlet) using one or more machine learning models trained for the selected outlet, as discussed in more detail above and below. One example method for generating the forecast for the selected outlet is described in more detail below with reference to FIG. 6.

At block 530, the forecasting system determines whether there is at least one additional outlet remaining in the indicated combination. If so, the method 500 returns to block 520. If not, the method 500 continues to block 535. Although the illustrated example depicts a sequential process (where each outlet is evaluated iteratively) for conceptual clarity, in some aspects, the forecasting system may generate some or all of the outlet-specific forecasts entirely or partially in parallel. Further, in some embodiments, the forecasting system may perform part of block 535 (e.g., determining the cross-outlet weight) in parallel with blocks 520, 525, and/or 530.

At block 535, the forecasting system aggregates the outlet-specific forecasts to generate an overall forecasted reach metric (or other metric such as impressions or frequency). In some embodiments, as discussed above, the forecasting system aggregates the forecasts by determining an upper bound (e.g., the sum of the outlet-specific forecasts across the proposed set of outlets) and a lower bound (e.g., the largest single-outlet forecast from the proposed set of outlets). The forecasting system can then determine a cross-outlet weight (e.g., a value between zero and one) which can be used to estimate the actual cross-outlet metric for the current distribution plan (e.g., based on historical data, as discussed above).

FIG. 6 is a flowchart depicting a method 600 for generating target forecasts using generalized models, according to some embodiments of the present disclosure. In some embodiments, the method 600 is performed by a forecasting system or service, such as the forecasting system 110 of FIG. 1, the forecasting layer 210 of FIG. 2, the forecasting service 212 of FIGS. 2-3, and/or the forecasting system discussed above with reference to FIGS. 4-5. In some embodiments, the method 600 provides additional detail for block 525 of FIG. 5.

At block 605, the forecasting system accesses a machine learning model trained for the selected distribution outlet (e.g., the outlet selected at block 520 of FIG. 5) and base segment of the distribution plan being evaluated (e.g., the base segment determined at block 515 of FIG. 5). For example, as discussed above, it may be impractical or impossible to maintain machine learning models trained for every possible segment (or even a substantial fraction thereof). Therefore, the forecasting system may train and/or maintain a significantly smaller set of models corresponding to one or more base segments (e.g., broader segments, such as defined by the age and sex of the segment members).

At block 610, the forecasting system generates an initial forecast for the distribution plan using the accessed machine learning model. That is, the forecasting system may process a variety of features of the distribution plan (e.g., timing of when content will be provided, duration of the campaign, any preferences or restraints with respect to what primary content the campaign materials should accompany, and the like) using the machine learning model trained for the identified base segment and selected outlet. That is, the initial forecast may indicate the predicted reach (or other metric) of the distribution plan with respect to the selected outlet and the base segment (e.g., the percentage of the individuals in the base segment that will see at least one piece of the targeted media content via the selected outlet).

At block 615, the forecasting system determines a segment ratio based on the target segment (specified in the distribution plan) and the base segment (identified as corresponding to the target segment and used to generate the initial forecast). For example, the forecasting system may determine the segment ratio by dividing the number of individuals known or estimated to be in the target segment by the number of individuals known or estimated to be in the base segment. In some embodiments, the segment ratio is cross-outlet. That is, the segment ratio may be determined based on global numbers (or estimates) regarding the size of the target segment and the base segment. In some embodiments, the segment ratio is outlet-specific. That is, the segment ratio may be determined based on the population size of the target segment and the base segment with respect to the particular outlet (e.g. allowing the segment ratio to vary across different outlets).

At block 620, the forecasting system scales the initial forecast (generated at block 610) by the segment ratio (determined at block 615) to generate an outlet-specific forecasted metric for the current outlet. For example, the forecasting system may multiply the initial forecast by the segment ratio. As discussed above, this forecast may generally indicate the predicted metric (e.g., reach) with respect to the given outlet and target segment.

FIGS. 7A-C illustrate cross-outlet reach for forecasting reach and frequency using models, according to one embodiment. In an embodiment, FIG. 7A illustrates a first scenario 700, with a disjoint set of viewers in each outlet. For example, an outlet 712 includes distinct viewers: Bob, Alice, and Jose, for a reach of 3. An outlet 714 includes distinct viewers Tim and Janice, for a reach of 2. The cross-outlet reach is 3+2−5. This disjoint scenario 700 illustrates the maximum value of reach available across outlet: the sum of reach in each outlet (e.g., 5 in this instance).

FIG. 7B illustrates a second scenario 730, with complete overlap of viewers across outlets. An outlet 742 includes three distinct viewers: Bob, Alice, and Jose, for a reach of 3. Another outlet 744 includes two distinct viewers Alice and Jose, for a reach of 2. But this overlapping case gives the minimum value of reach available across outlets, the max of reach on any outlet: here, max(3, 2)=3.

FIG. 7C illustrates a third scenario 770, with some overlap of viewers across outlets. An outlet 782 includes distinct viewers Bob, Alice, Jose, and Tim, with a reach of 4. Another outlet 784 includes distinct viewers Bob, Janice, and Tim, with a reach of 3. In this example, some, but not all, viewers overlap across outlets, so that the value of the cross-outlet reach falls between the max(4, 3)=4 and sum(4, 3)=7. In this instance, the cross outlet reach is 5.

Thus, as discussed above in relation to block 304, cross-outlet reach has natural lower and upper bounds. Since reach is defined as the unique number of individuals that watch a set of content associated with a distribution plan (e.g., advertisement), cross-outlet reach is bounded below by the maximum value of reach on any single outlet (e.g., 4 in the example of FIG. 7C) and bounded above by the sum of the reach values on each outlet (e.g., 7 in the example of FIG. 7C). The cross-outlet reach is bounded between 4 and 7 in the example of FIG. 7C (e.g., 5 in this example).

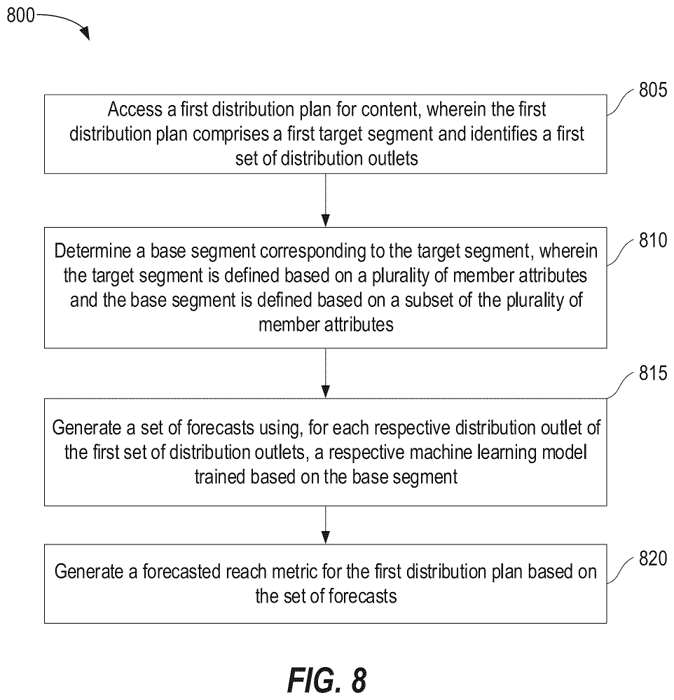

FIG. 8 is a flowchart depicting a method 800 for generating forecasts using machine learning models, according to some embodiments of the present disclosure. In some embodiments, the method 800 is performed by a forecasting system or service, such as the forecasting system 110 of FIG. 1, the forecasting layer 210 of FIG. 2, the forecasting service 212 of FIGS. 2-3, and/or the forecasting system discussed above with reference to FIGS. 4-7A, 7B, and 7C.

At block 805, a first distribution plan (e.g., the distribution plan 105 of FIG. 1) for content (e.g., the media content 125 of FIG. 1) is accessed, wherein the first distribution plan comprises a first target segment and identifies a first set of distribution outlets (e.g., the distribution outlets 130 of FIG. 1).

At block 810, a base segment corresponding to the target segment is determined, wherein the target segment is defined based on a plurality of member attributes and the base segment is defined based on a subset of the plurality of member attributes.

At block 815, a set of forecasts (e.g., outlet-specific forecasts, as discussed above) is generated using, for each respective distribution outlet of the first set of distribution outlets, a respective machine learning model trained based on the base segment.

At block 820, a forecasted reach metric (e.g., the forecast 115 of FIG. 1) for the first distribution plan is generated based on the set of forecasts.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
accessing a first distribution plan for content, wherein the first distribution plan comprises a first target segment and identifies a first set of distribution outlets;
determining a base segment corresponding to the target segment, wherein the target segment is defined based on a plurality of member attributes and the base segment is defined based on a subset of the plurality of member attributes;
generating a set of forecasts using, for each respective distribution outlet of the first set of distribution outlets, a respective machine learning model trained based on the base segment; and
generating a forecasted reach metric for the first distribution plan based on the set of forecasts.

2. The method of claim 1, wherein generating the set of forecasts comprises determining a first segment ratio based on the first target segment and the base segment with respect to a first distribution outlet of the set of distribution outlets.

3. The method of claim 2, wherein generating the set of forecasts further comprises:
accessing a first machine learning model trained for the first distribution outlet and based on the base segment;
generating a first initial forecast using the first machine learning model and based on the first distribution plan; and
scaling the first initial forecast based on the first segment ratio to generate a first forecast of the set of forecasts.

4. The method of claim 1, wherein:
the subset of the plurality of member attributes comprises (i) member sex and (ii) member age, and
the plurality of member attributes comprise at least one additional member attribute in addition to member sex and member age.

5. The method of claim 1, further comprising determining a cross-outlet weight based at least in part on the first set of distribution outlets, wherein the forecasted reach metric is generated based further on the cross-outlet weight.

6. The method of claim 5, wherein generating the forecasted reach metric comprises:
determining an upper bound of the forecasted reach metric based on the set of forecasts;
determining a lower bound of the forecasted reach metric based on the set of forecasts; and
generating the forecasted reach metric based on the upper bound, the lower bound, and the cross-outlet weight.

7. The method of claim 5, wherein determining the cross-outlet weight comprises determining a historical cross-outlet weight corresponding to the base demographic and the set of distribution outlets.

8. The method of claim 5, wherein determining the cross-outlet weight comprises determining a historical cross-outlet weight corresponding to the base demographic and a combination of distribution outlets that comprises the set of distribution outlets and at least one additional distribution outlet.

9. The method of claim 5, wherein determining the cross-outlet weight comprises determining a historical cross-outlet weight corresponding to the base demographic across all distribution outlets.

10. One or more non-transitory computer readable media containing, in any combination, computer program code that, when executed by operation of any combination of one or more processors, performs an operation comprising:
accessing a first distribution plan for content, wherein the first distribution plan comprises a first target segment and identifies a first set of distribution outlets;
determining a base segment corresponding to the target segment, wherein the target segment is defined based on a plurality of member attributes and the base segment is defined based on a subset of the plurality of member attributes;
generating a set of forecasts using, for each respective distribution outlet of the first set of distribution outlets, a respective machine learning model trained based on the base segment; and
generating a forecasted reach metric for the first distribution plan based on the set of forecasts.

11. The one or more non-transitory computer readable media of claim 10, wherein generating the set of forecasts comprises determining a first segment ratio based on the first target segment and the base segment with respect to a first distribution outlet of the set of distribution outlets.

12. The one or more non-transitory computer readable media of claim 11, wherein generating the set of forecasts further comprises:
accessing a first machine learning model trained for the first distribution outlet and based on the base segment;
generating a first initial forecast using the first machine learning model and based on the first distribution plan; and
scaling the first initial forecast based on the first segment ratio to generate a first forecast of the set of forecasts.

13. The one or more non-transitory computer readable media of claim 10, wherein:
the subset of the plurality of member attributes comprises (i) member sex and (ii) member age, and
the plurality of member attributes comprise at least one additional member attribute in addition to member sex and member age.

14. The one or more non-transitory computer readable media of claim 10, the operation further comprising determining a cross-outlet weight based at least in part on the first set of distribution outlets, wherein the forecasted reach metric is generated based further on the cross-outlet weight.

15. The one or more non-transitory computer readable media of claim 14, wherein generating the forecasted reach metric comprises:
determining an upper bound of the forecasted reach metric based on the set of forecasts;
determining a lower bound of the forecasted reach metric based on the set of forecasts; and
generating the forecasted reach metric based on the upper bound, the lower bound, and the cross-outlet weight.

16. A system, comprising:
one or more processors; and
one or more memories storing a program, which, when executed on any combination of the one or more processors, performs operations, the operations comprising:
accessing a first distribution plan for content, wherein the first distribution plan comprises a first target segment and identifies a first set of distribution outlets;
determining a base segment corresponding to the target segment, wherein the target segment is defined based on a plurality of member attributes and the base segment is defined based on a subset of the plurality of member attributes;
generating a set of forecasts using, for each respective distribution outlet of the first set of distribution outlets, a respective machine learning model trained based on the base segment; and
generating a forecasted reach metric for the first distribution plan based on the set of forecasts.

17. The system of claim 16, wherein generating the set of forecasts comprises determining a first segment ratio based on the first target segment and the base segment with respect to a first distribution outlet of the set of distribution outlets.

18. The system of claim 17, wherein generating the set of forecasts further comprises:
accessing a first machine learning model trained for the first distribution outlet and based on the base segment;
generating a first initial forecast using the first machine learning model and based on the first distribution plan; and
scaling the first initial forecast based on the first segment ratio to generate a first forecast of the set of forecasts.

19. The system of claim 16, the operation further comprising determining a cross-outlet weight based at least in part on the first set of distribution outlets, wherein the forecasted reach metric is generated based further on the cross-outlet weight.

20. The system of claim 19, wherein generating the forecasted reach metric comprises:
determining an upper bound of the forecasted reach metric based on the set of forecasts;
determining a lower bound of the forecasted reach metric based on the set of forecasts; and
generating the forecasted reach metric based on the upper bound, the lower bound, and the cross-outlet weight.
